(19) United States
(12) Patent Application Publication
(10) Pub. No.: US 2026/0122466 A1
(43) Pub. Date: Apr. 30, 2026

(54) APPARATUS AND METHOD FOR DYNAMIC DISCOVERY AND REDIRECTION OF SECURITY GATEWAYS IN MOBILE COMMUNICATIONS NETWORKS

(71) Applicant: Deutsche Telekom AG, Bonn (DE)

(72) Inventors: Mohamed IBRAHIM, Bonn (DE); Sven LACHMUND, Munich (DE)

(21) Appl. No.: 19/040,912

(22) Filed: Jan. 30, 2025

(30) Foreign Application Priority Data
Oct. 30, 2024 (EP) 24209718.6

(51) Int. Cl. H04W 8/00; H04L 61/4511; H04W 84/04

(52) U.S. Cl. CPC H04W 8/005; H04L 61/4511; H04W 84/042

(57) ABSTRACT

A method for dynamic discovery and redirection of security gateways in mobile communications networks, the method comprising: based on a first domain name, initiating, by a first security gateway in a first mobile communications network, communication between the first security gateway in the first mobile communications network and a second security gateway in a second mobile communications network; receiving, by the first security gateway, a redirection response from the second security gateway, the redirection response being indicative of a second domain name to be used for Domain Name System (DNS)-based discovery of another security gateway in the second mobile communications network; and based on the second domain name, initiating, by the first security gateway, communication between the first security gateway in the first mobile communications network and a third security gateway in the second mobile communications network.

### CROSS-REFERENCE TO PRIOR APPLICATIONS

This application claims benefit to European Patent Application No. EP 24209718.6, filed on Oct. 30, 2024, which is hereby incorporated by reference herein.

### FIELD

The present disclosure relates to the field of mobile communications networks, specifically to methods and apparatuses for dynamic discovery and redirection of security gateways to manage inter-network communication and ensure secure and efficient traffic routing.

### BACKGROUND

The evolution of mobile networks has culminated in the deployment of 5G standalone (SA) networks, which represent a significant leap from earlier technologies. Unlike 5G non-standalone (NSA) networks that rely on existing 4G LTE infrastructure, 5G SA networks operate with a dedicated 5G core (5GC) and fully exploit the capabilities of 5G technology. This brings enhancements such as ultra-low latency, high throughput, and support for massive Internet of Things (IoT) applications. In this context, the Security Edge Protection Proxy (SEPP) plays a vital role in ensuring secure communication between different mobile network operators, particularly in roaming scenarios where multiple public land mobile networks (PLMNs) interact.

A Security Edge Protection Proxy (SEPP) is a security gateway that may ensure confidentiality, integrity, and authenticity of signaling messages exchanged between networks in 5G environments. As 5G networks facilitate communication between various public land mobile networks (PLMNs), SEPPs may be deployed at the edge of each network to secure inter-network exchanges. These exchanges may be facilitated via the inter-PLMN interface N32, which allows two SEPPs from different PLMNs to interact securely, protecting sensitive data and maintaining network integrity. The SEPP ensures that communications between networks are encrypted, preventing unauthorized access, tampering, or data leakage.

However, the current standards governing SEPP operation in 5G, such as those defined by the 3rd Generation Partnership Project (3GPP), face a limitation when it comes to dynamically directing traffic between multiple SEPPs within the same PLMN. In certain situations, an operator may deploy multiple SEPPs for various reasons, such as load balancing, failover mechanisms, or routing based on specific network functions or roaming partner requirements. Existing standards, however, offer no clear mechanism for dynamically discovering and routing traffic to different SEPPs based on these needs. The process of selecting a SEPP is currently constrained by Domain Name System (DNS) queries, which always return the same SEPP for a given PLMN, limiting the flexibility needed for dynamic traffic management.

This limitation may become particularly problematic in 5G SA networks, where flexibility in routing roaming traffic may be essential for optimizing network performance and ensuring seamless communication between partners. In roaming scenarios, where multiple SEPPs may be deployed within a single PLMN, the inability to dynamically select and redirect traffic to different SEPPs may hinder the network's ability to adapt to varying conditions and traffic demands. This may not only affect load distribution and failover capabilities but may also reduce the network's efficiency in handling complex roaming use cases that require targeted routing.

A problem to be solved lies in the lack of a mechanism that allows for dynamic redirection of SEPP traffic within and between PLMNs. While existing specifications offer some redirection capabilities through Hypertext Transfer Protocol (HTTP) responses, these are inadequate for scenarios where multiple SEPPs need to be dynamically discovered and selected based on specific operational requirements. The current reliance on static DNS responses and limited redirection options prevents operators from achieving the full flexibility that 5G SA networks are designed to offer, creating a need for a more adaptive approach to SEPP discovery and redirection.

### SUMMARY

In an exemplary embodiment, the present invention provides a method for dynamic discovery and redirection of security gateways in mobile communications networks. The method includes: based on a first domain name, initiating, by a first security gateway in a first mobile communications network, communication between the first security gateway in the first mobile communications network and a second security gateway in a second mobile communications network; receiving, by the first security gateway, a redirection response from the second security gateway, the redirection response being indicative of a second domain name to be used for Domain Name System (DNS)-based discovery of another security gateway in the second mobile communications network; and based on the second domain name, initiating, by the first security gateway, communication between the first security gateway in the first mobile communications network and a third security gateway in the second mobile communications network.

### BRIEF DESCRIPTION OF THE FIGURES

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a network architecture for mobile communications networks, according to aspects of the present disclosure;

FIG. 2 depicts a flowchart for a method of dynamic discovery and redirection of security gateways, according to an embodiment;

FIG. 3 depicts a block diagram of an apparatus of dynamic discovery and redirection of security gateways, according to an embodiment; and

FIG. 4 shows a sequence diagram of a dynamic discovery and redirection process for security gateways, in accordance with example embodiments.

### DETAILED DESCRIPTION

According to a first aspect of the present disclosure, a method for dynamic discovery and redirection of security gateways in mobile communications networks is provided. The method includes, based on a first domain name, initiating communication between a first security gateway in a first mobile communications network and a second security gateway in a second mobile communications network. The method further includes receiving a redirection response from the second security gateway. The redirection response is indicative of a second domain name to be used for DNS-based discovery of another security gateway in the second mobile communications network. The method further includes, based on the second domain name, redirecting the communication from the first security gateway in the first mobile communications network to a third security gateway in the second mobile communications network. The method may dynamically discover security gateways in different mobile networks. By initiating communication between the gateways and using redirection responses, the system may allow flexible routing of traffic. This may ensure optimized communication paths and load balancing, benefiting roaming scenarios in mobile networks.

According to some embodiments, the redirection response is received via an inter-mobile-communications-network interface. This may enable seamless inter-network communication, particularly useful in roaming scenarios where different PLMNs are involved. According to some embodiments, the inter-mobile-communications-network interface is an inter-PLMN interface. One commonly known inter-PLMN interface is the N32 interface, which is used specifically in 5G networks for secure communication between SEPPs. The N32 interface ensures that signaling messages exchanged between different mobile operators are protected during roaming scenarios. Another well-known inter-PLMN interface is the S8 interface, which is part of the 4G LTE architecture, allowing user plane data transfer between the Serving Gateway (SGW) in the visited PLMN and the Packet Data Network Gateway (PGW) in the home PLMN during roaming. These interfaces may facilitate secure and efficient communication between networks operated by different mobile providers. Using an inter-PLMN interface may facilitate communication between security gateways of different mobile operators, may enhance roaming capabilities and may ensure that traffic can be dynamically redirected between networks. This may support more flexible and resilient network architectures.

According to some embodiments, initiating communication between the first and the second security gateway comprises constructing the first domain name for a target security gateway in the second mobile communications network based on a network ID of the second mobile communications network. Constructing the domain name based on the network ID may provide a clear and organized method for identifying and addressing security gateways in the second mobile communications network. This may help in accurately routing traffic to the correct gateway, improving communication efficiency. For another example, domain names can be generated based on predefined naming conventions that incorporate additional factors such as a location of the gateway, the type of service being accessed, or specific security requirements. Another approach could involve dynamically constructing domain names based on the load balancing or performance metrics of the available security gateways, ensuring optimal traffic routing. Furthermore, domain names could be created by leveraging hierarchical naming schemes where different components of the domain reflect various levels of the network architecture, such as the operator's name, geographic region, or service-specific identifiers.

According to some embodiments, initiating communication between the first and the second security gateway comprises performing a DNS query using the first domain name to obtain a list of security gateways in the second mobile communications network. Using DNS queries may allow for dynamic discovery of available security gateways in the second network. This may enable more efficient and real-time identification of potential gateways for communication, increasing flexibility and resilience in network management. For another example, a centralized registry or database could be used, where security gateways are pre-registered, and the initiating gateway can directly query this registry to obtain relevant information. Alternatively, the communication between security gateways could leverage dynamic service discovery protocols, such as Service Location Protocol (SLP) or Universal Plug and Play (UPnP), to discover available gateways. Additionally, peer-to-peer communication between gateways could enable direct gateway advertisement, where each security gateway periodically broadcasts its availability to other network nodes without requiring a DNS lookup.

According to some embodiments, the method further comprises selecting a security gateway from the list and initiating communication between the first security gateway and the selected second security gateway in the second mobile communications network. The selection of a security gateway from the list may take place based on several criteria. One common criterion may be load balancing, where the gateway with the least traffic or optimal capacity is chosen to prevent overloading any single gateway. Another criterion could be geographical proximity, selecting the gateway that is physically closest to the user or the source of the traffic to minimize latency. Security policies might also influence the selection, prioritizing gateways that meet certain encryption or data protection standards. Additionally, the selection could be based on network performance metrics such as response times, bandwidth availability, or packet loss rates to ensure the best quality of service. Gateway availability and redundancy could also play a role, with the system preferring gateways that have high uptime or offer failover support in case of network disruptions. Such criteria may ensure that the most suitable security gateway is selected to maintain optimal performance and security. The selection of a specific gateway from the list may ensure that traffic can be optimally routed through the most suitable gateway, potentially based on factors like load or geographic location. This may contribute to improved network performance and resource management.

According to some embodiments, initiating communication between the first and the third security gateway comprises performing a second DNS query using the second domain name to dynamically discover a new target security gateway. By performing a second DNS query, the method may further enhance dynamic discovery by allowing for real-time adjustment of the communication path as new gateways are discovered. This flexibility may ensure optimized network routing. For another example, a centralized registry or database could be used, where security gateways are pre-registered, and the initiating gateway can directly query this registry to obtain relevant information. Alternatively, the communication between security gateways could leverage dynamic service discovery protocols, such as SLP or UPnP, to discover available gateways.

According to some embodiments, the method further comprises redirecting the communication to the new target security gateway based on the results of the second DNS query. The second DNS query may return a second list of target security gateways in the second mobile communications network, similar to how the first DNS query provided the initial list. This second list would contain available security gateways that are suitable for handling the redirected communication. The list may include multiple gateways that meet specific criteria, such as location, capacity, or service type. Based on this second list, the system can then dynamically select the most appropriate target security gateway for the redirected communication, ensuring that the communication is efficiently routed through the best available gateway in the network. Redirecting the communication based on the second DNS query may allow the method to adjust the communication flow dynamically, ensuring that traffic is directed through the most efficient or available security gateway. This may improve both reliability and scalability in the network.

According to some embodiments, the DNS queries comprise respective DNS Naming Authority Pointer (NAPTR) queries. Using NAPTR queries as part of the DNS process may enable more complex and flexible service discovery, allowing the network to resolve not just the gateway's address but also the services provided. This may enhance the system's ability to adapt to varying network needs. For another example, SRV (Service) queries could be used to locate specific services within a network by identifying the hostname and port number of the server providing the desired service. Additionally, A (Address) queries or AAAA (IPv6 Address) queries could be employed to directly resolve domain names into their corresponding IPv4 or IPv6 addresses, bypassing service discovery. CNAME (Canonical Name) queries could also be used to map an alias name to a canonical domain name, facilitating flexible redirection.

According to some embodiments, the security gateways comprise respective SEPPs. The use of SEPPs as the security gateways may ensure that the communication between different mobile networks is secure, especially in roaming scenarios. SEPPs may protect the integrity of signaling messages between networks, providing a critical layer of security. There are several other types of security gateways used in mobile and communication networks. One example is the Security Gateway (SEG) used in IP-based networks, particularly for securing IPsec tunnels between different network segments or between a user and a network. Another example is the Border Gateway Function (BGF), which may be used in telecommunications networks to manage and secure traffic at the boundary of a service provider's network. Additionally, in 4G LTE networks, the Diameter Edge Agent (DEA) serves as a security gateway to control and secure Diameter signaling traffic between networks. These gateways, like SEPPs, are responsible for securing inter-network communications, ensuring privacy, and managing access between different network domains or operators.

According to some embodiments, the first and second mobile communications networks comprise respective 5G Standalone (SA) networks. Applying the method to 5G SA networks may enhance the performance and flexibility of next-generation mobile networks, enabling better handling of security and communication in advanced mobile architectures.

This may result in improved network slicing and security. The skilled person having benefit from the present disclosure will appreciate that embodiments of the present disclosure may be applicable not only to 5G SA networks but also to other communication networks that employ security gateways. By leveraging domain names and redirection responses, embodiments of the present disclosure can be adapted to manage secure communication across a variety of network architectures, enabling dynamic discovery and redirection of gateways in networks that require secure and efficient routing of traffic between different operators or regions. This flexibility ensures that embodiments of the present disclosure can optimize communication paths and load balancing in both next-generation and legacy mobile networks, enhancing overall network performance and security.

According to some embodiments, the domain names comprise respective fully qualified domain names (FQDNs). Using FQDNs for addressing security gateways may ensure clarity and precision in the communication process, allowing networks to easily resolve and communicate with the correct endpoints. This may improve reliability and reduce errors in routing. For another example, partially qualified domain names (PQDNs) could be used, where only a portion of the domain is specified, and the missing parts may be inferred based on local network context. Additionally, relative domain names might be utilized, which may be interpreted relative to a predefined domain, typically within the same network or organization. In specific closed network environments, custom domain naming schemes could also be applied, where domain names are structured differently to meet particular security or operational requirements.

According to some embodiments, the redirection response comprises a Hypertext Transfer Protocol (HTTP) redirection response. An HTTP redirection response may allow the method to leverage a widely-used protocol for directing communication, ensuring compatibility and ease of integration into existing network infrastructures. This may simplify the process and enhances scalability. For another example, SIP (Session Initiation Protocol) redirection responses could be used in networks where voice, video, or messaging services are involved, allowing the redirection of communication sessions to alternate endpoints. In IP-based networks, DNS-based redirection responses could also be used, where DNS responses redirect traffic by providing alternative IP addresses or domain names. Additionally, application-layer redirection protocols, such as Diameter or GTP (GPRS Tunneling Protocol), could be employed in telecommunications networks to handle redirection of signaling or data traffic between nodes.

According to another aspect of the present disclosure, an apparatus for dynamic discovery and redirection of security gateways in mobile communications networks is provided. The apparatus comprises processing circuitry configured to: based on a first domain name, initiate communication between a first security gateway in a first mobile communications network and a second security gateway in a second mobile communications network, receive a redirection response from the second security gateway, the redirection response being indicative of a second domain name to be used for DNS-based discovery of another security gateway in the second mobile communications network, and based on the second domain name, redirect the communication from the first security gateway in the first mobile communications network to a third security gateway in the second mobile communications network. The apparatus may allow for dynamic discovery and redirection of communication paths between security gateways, facilitating seamless communication across mobile networks. This may lead to a flexible and efficient system for managing inter-network traffic, improving both security and performance.

According to another aspect of the present disclosure, a method for dynamic discovery and redirection of security gateways in mobile communications networks is provided. The method includes, based on a first domain name, initiating communication between a first security gateway in a first mobile communications network and a second security gateway in a second mobile communications network, and transmitting a redirection response from the second security gateway to the first security gateway, the redirection response being indicative of a second domain name to be used for DNS-based discovery of another security gateway in the second mobile communications network. This method is from the perspective of the second security gateway, which actively transmits the redirection response, allowing the first gateway to redirect traffic accordingly. This approach may enable the second gateway to influence traffic routing, offering more control over network paths and improving traffic distribution.

According to another aspect of the present disclosure, an apparatus for dynamic discovery and redirection of security gateways in mobile communications networks is provided. The apparatus comprises processing circuitry configured to, based on a first domain name, initiate communication between a first security gateway in a first mobile communications network and a second security gateway in a second mobile communications network, and transmit a redirection response from the second security gateway to the first security gateway, the redirection response being indicative of a second domain name. This apparatus may enable the second security gateway to take an active role in the redirection process, optimizing network resource utilization by guiding the first security gateway towards the best available communication paths. This may improve load balancing and network management.

Embodiments of the present disclosure provide methods and apparatuses for dynamic discovery and redirection of security gateways in mobile communication networks, focusing on optimizing inter-network traffic. The embodiments involve initiating communication between security gateways based on domain names and utilizing DNS queries to discover available security gateways dynamically. The embodiments support seamless redirection to more suitable gateways, allowing flexible routing and load balancing, particularly beneficial in roaming scenarios. Using Security Edge Protection Proxies (SEPPs), DNS NAPTR queries, and FQDNs for addressing may ensures security and efficiency.

Redirection responses, HTTP protocols, and inter-PLMN interfaces may enable the embodiments to adjust communication paths dynamically, improving performance and resilience in 5G standalone networks.

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

A PLMN operator is an organization that deploys and operates mobile networks. The technology for these networks may be defined in 3GPP (3rd Generation Partnership Project) specifications, and operational aspects may be defined by GSMA (GSM Association). This applies for 5G networks and the previous generations.

In the 5G specifications, it is defined that for inter-PLMN communication, i.e. roaming, a non-transparent proxy, the Security Edge Protection Proxy (SEPP) is used. The SEPP may establish communication between two PLMNs and it may protect the network edge of the PLMN. Inter-PLMN communication refers to the communication between two different PLMNs, which typically occurs in roaming scenarios when a mobile user connects to a network outside their home operator's network. To secure and manage this communication, a SEPP may be used. A SEPP may serve as a security gateway in 5G networks, specifically designed to safeguard communications between different PLMNs during inter-network interactions, such as roaming. Acting as a secure intermediary, the SEPP may ensure that all signaling traffic exchanged between two networks remains protected and confidential. It may prevent exposure of sensitive network details by enforcing encryption and integrity protection, effectively guarding the network perimeter from potential threats. As a gateway, the SEPP may enable secure and efficient exchange of messages while preventing unauthorized access or manipulation of network resources. Its role is needed for maintaining the security and integrity of 5G communication, especially in scenarios where multiple mobile operators must collaborate without compromising their internal network structures.

The inter-PLMN interface between two SEPPs is called N32. The N32 interface may allow SEPPs to exchange signaling messages securely between networks, ensuring that communication during roaming or other inter-network activities is protected. It may enable the SEPPs to establish and maintain secure connections, applying encryption and other security mechanisms to safeguard the integrity and confidentiality of data transmitted between the two PLMNs. By using N32, SEPPs can securely manage and route traffic across different mobile networks without exposing sensitive information to external parties.

For roaming, each PLMN may be identified by a globally unique PLMN identifier (ID). There may be a global registry for these IDs. The PLMN ID may be used for identifying and differentiating networks, particularly when users connect to foreign networks during roaming. This unique identification may help ensure that devices can correctly authenticate and establish connections with the appropriate network. Additionally, there may be a global registry that maintains and manages these PLMN IDs, ensuring they are unique and avoiding conflicts between network operators across different countries and regions. This registry may allow smooth operation of international mobile communications.

For one SEPP to establish communication with another SEPP, it may construct the well-known fully qualified domain name (FQDN). The well-known FQDN comprises the PLMN ID and the domain “3gppnetwork.org”. As soon as the PLMN ID is known, the well-known FQDN can be constructed. This describes how one SEPP may communicate with another SEPP across different mobile networks. To initiate this communication, the SEPP constructs the well-known FQDN, which is essentially a structured web address used to identify the target SEPP. This FQDN is created by combining the unique identifier of the target network, known as the PLMN ID, with the standard domain name “3gppnetwork.org,” which is used universally for 5G networks. This approach may ensure that SEPPs can correctly identify and locate each other across different PLMNs.

To discover a SEPP, the well-known FQDN may be used in a DNS NAPTR (Naming Authority Pointer) query to obtain a list of purposes. A NAPTR query is a type of DNS query that may resolve domain names to services or specific functions. By using this query, the SEPP can retrieve a list of purposes or available services offered by the target SEPP. This may allow the initiating SEPP to understand the capabilities of the other SEPP and choose the correct one for communication, ensuring proper handling of signaling and security between networks.

From the list, the initiating SEPP may select the intended purpose and perform an SRV (Service) request on the selected entry. That is, after the initiating SEPP receives a list of purposes or services from the DNS NAPTR query, it may select the appropriate one based on its intended purpose for communication. Once the correct service or function is identified, the SEPP performs an SRV request on that selected entry. An SRV request is a type of DNS query used to locate the specific server or service that can handle the communication. This may allow the initiating SEPP to find the exact SEPP instance that can fulfill its communication needs, ensuring a precise and efficient connection between the networks.

The DNS server may respond with a prioritized and weighted list of SEPPs FQDNs. The initiating SEPP may choose one of them, send a DNS query to obtain the IP address (A or AAAA) and finally communicate with the IP address, which belongs to the chosen destination SEPP. That is, after the initiating SEPP performs an SRV request, the DNS server may respond with a list of FQDNs representing available SEPPs, along with priority and weight values. These values may help the initiating SEPP determine the most suitable SEPP to communicate with, based on factors such as load balancing or proximity. Once a SEPP is chosen from this list, the initiating SEPP may send a DNS query to resolve the FQDN into an IP address, which can be either an IPv4 (A) or IPv6 (AAAA) address. The initiating SEPP may then use this IP address to establish direct communication with the selected SEPP in the destination network.

This approach may allow a SEPP to discover the IP address of the peer SEPP of the roaming partner with only knowing the PLMN ID. No prior knowledge beyond that or configuration is required.

The 3GPP specifications define HTTP redirection for a SEPP to inform an initiating entity that another SEPP should be used. In this redirection response, the FQDN of the intended new target SEPP is contained. This FQDN can be resolved to an IP address via a DNS A or AAAA query. That means if an initiating SEPP attempts to communicate with a target SEPP that is not the most suitable for the task, the target SEPP can send an HTTP redirection response to inform the initiating SEPP to use a different SEPP instead. This redirection response may contain the FQDN of the new target SEPP. The initiating SEPP can then resolve this FQDN into an IP address through a DNS query, either using an A record for IPv4 or an AAAA record for IPv6. This process may allow the initiating SEPP to redirect its communication to the appropriate SEPP, ensuring optimized routing and network efficiency.

A limitation is that DNS always responds with the same answers. If a PLMN wants to direct certain roaming partners to dedicated SEPPs the current standards do not allow for this. When a DNS query is made, it may always provide the same set of responses for a given request, without considering specific conditions or preferences. This means that if a mobile network operator (PLMN) wants to route traffic from certain roaming partners to specific, dedicated SEPPs, the existing standards do not support this level of customization. The operator cannot control which SEPP a roaming partner connects to, as DNS responses lack the flexibility to direct different partners to different SEPPs based on their identity or other factors. This limits the ability to optimize routing and load distribution in roaming scenarios.

Currently, a SEPP may redirect an HTTP request towards a different SEPP over a non-N32 interface by sending a 307 Temporary Redirect or 308 Permanent Redirect response to the HTTP client including a RedirectResponse data structure. The location header is ignored, and contents of RedirectResponse (targetSepp information element (IE)) is used. In such cases, the SEPP can send an HTTP redirection response, specifically a 307 Temporary Redirect or a 308 Permanent Redirect, to the HTTP client. Instead of using the standard HTTP location header for the redirection, which is typically used in other types of web redirections, the SEPP includes a specialized data structure called a RedirectResponse. This structure contains a specific information element known as the targetSepp information element (IE), which directs the client to the new SEPP. The location header is ignored in this process, and only the information within the RedirectResponse is used to handle the redirection, ensuring that the traffic is properly routed to the intended SEPP.

This approach may be used when an element, a so-called Network Function (NF) inside the PLMN wants to communicate with another PLMN. The NF sends its messages to the SEPP of its own PLMN for delivery. This SEPP can tell the NF to use another SEPP for sending instead. This is an intra-PLMN communication and therefore irrelevant for roaming.

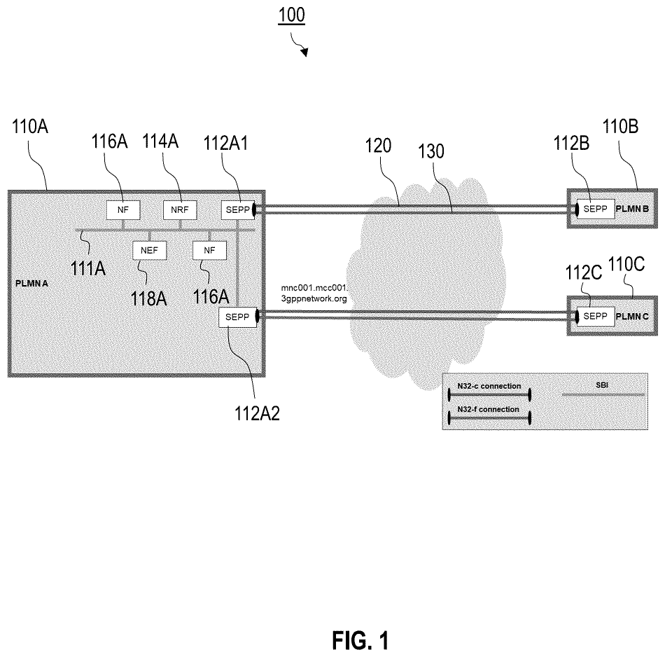

On contrary, an N32 HTTP request may be redirected to a different SEPP service instance located within the same PLMN. An example scenario is illustrated in FIG. 1.

Referring to FIG. 1, it is illustrated a network architecture 100 for mobile communications networks. The depicted architecture 100 includes multiple PLMNs 110A, 110B, 110C, specifically PLMN A, PLMN B, and PLMN C. Each PLMN may be a 5G Standalone (SA) network, and each may include at least one SEPP 112. The SEPPs 112, which may be implemented as processing circuitry, serve as security gateways for inter-PLMN communication.

In the illustrated example, PLMN A includes two SEPPs, SEPP 112A1 and SEPP 112A2. SEPP 112A1 is connected to PLMN B via an inter-mobile-communications-network-interface 120, 130, such as an inter-PLMN interface, represented by a N32 connection. Similarly, SEPP 112A2 is connected to PLMN C via another inter-PLMN (N32) interface 120, 130. PLMN B and PLMN C each have their own SEPPs, SEPP 112B and SEPP 112C respectively, for connecting to PLMN A.

In PLMN A, various network functions (NF) 116A such as the NRF (Network Repository Function) 114A and NEF (Network Exposure Function) 118A are shown as part of the 5G Service-Based Architecture (SBA). These network functions may interact with SEPPs 112A1, 112A2 via an SBI (Service-Based Interface) connection 111A, which may handle internal communication within PLMN A. The SEPPs 112A1, 112A2, in turn, may establish secure external communication with SEPPs in PLMN B and PLMN C through N32 connections 120, 130. The N32 interface is split into two parts: the N32-c connection 120 and the N32-f connection 130. The N32-c connection 120 may be used for control-plane signaling between SEPPs, including security negotiations and parameter exchanges, while the N32-f connection 130 may handle the forwarding of protected application-layer messages between the networks. The cloud in the center represents a broader internet or IP exchange network through which the SEPPs may communicate across different PLMNs, ensuring that signaling and data between networks are secure, especially in roaming scenarios. It also includes a central domain, represented by the “mnc001.mcc001.3gppnetwork.org” domain. This domain may be used for DNS-based SEPP discovery, facilitating inter-PLMN communication.

In some aspects, the multiple SEPPs within PLMN A, specifically SEPP 112A1 and SEPP 112A2, may serve different purposes. For instance, a PLMN operator may choose to connect with certain roaming partners through one SEPP while using a different SEPP for others. This approach allows the operator to route specific roaming partners to particular SEPPs based on their preferences. For example, SEPP 112A1 may be used to connect with PLMN B, while SEPP 112A2 may be used to connect with PLMN C.

In some cases, the deployment of multiple SEPPs within a single PLMN, such as PLMN A, can facilitate load balancing. Load balancing can be achieved by distributing network traffic across multiple SEPPs to ensure that no single SEPP becomes overwhelmed with traffic. This can enhance the efficiency and reliability of the network by preventing any single point of failure and ensuring that network resources are utilized optimally.

In some aspects, the multiple SEPPs 112A1, 112A2 within PLMN A can also facilitate failover mechanisms. A failover mechanism is a backup operational mode in which the functions of a system component, such as a SEPP, are assumed by secondary system components when the primary component becomes unavailable. In the context of the present disclosure, if one SEPP within PLMN A becomes unavailable or fails, the other SEPP can take over its functions, thereby ensuring uninterrupted service.

Furthermore, the multiple SEPPs 112A1, 112A2 within PLMN A can be used to implement traffic prioritization and routing based on targeted Network Functions (NFs). In some cases, certain types of traffic or certain NFs may be given priority and routed through a specific SEPP. For example, traffic related to emergency services or critical infrastructure may be given priority and routed through a specific SEPP to ensure reliable and timely communication.

For example, SEPP 112A1 in PLMN A may receive a N32 HTTP request from another, e.g. SEPP 112B that is in PLMN B and redirect the request to another SEPP 112A2 in PLMN A. SEPP 112A1 may send a 307 Temporary Redirect response to SEPP 112B and may include a RedirectResponse data structure. The location header is used, and contents of RedirectResponse(targetSepp IE) is ignored.

The HTTP Location header is defined in the HTTP RFC. The RFC says that the Location header consists of a URI, which contains an FQDN. This FQDN may be interpreted as Host FQDN. The RFC does not leave any room for any other interpretation.

Informing the initiating SEPP 112B with this approach of a new target SEPP 112A2 only allows the PLMN A to respond with a dedicated SEPP FQDN. This reduces flexibility, as for the new target SEPP 112A2 it is not possible to perform DNS-based SEPP discovery again.

The present disclosure provides a method, apparatus, and system for dynamic discovery and redirection of security gateways in mobile communications networks. This may be particularly relevant in the context of 5G networks, where SEPPs play a role in safeguarding the edges of mobile networks and facilitating secure inter-network communication. The disclosed methods and apparatuses address the need for more flexible and dynamic routing of traffic to specific SEPPs based on various criteria or preferences, a capability that is currently lacking in existing standards. This is particularly beneficial in scenarios where a PLMN operator wishes to direct certain roaming partners to dedicated SEPPs while using different ones for others. The disclosed methods and apparatuses may also overcome the limitations of the static nature of DNS responses in the current setup, enabling a new round of DNS-based SEPP discovery upon redirection and thereby facilitating advanced load balancing or failover strategies. Furthermore, the disclosed methods and apparatuses may eliminate the need for prior configuration or knowledge by the initiating network, thereby reducing complexity in network management and enhancing agility in responding to changing network conditions or security requirements.

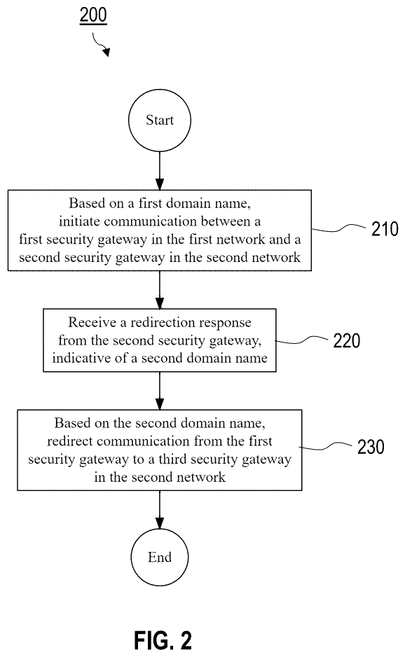

Referring to FIG. 2, it is illustrated a flowchart for a method 200 of dynamic discovery and redirection of security gateways in mobile communications networks.

The method 200 includes initiating 210 communication between a first security gateway in a first mobile communications network and a second security gateway in a second mobile communications network based on a first domain name.

In some aspects, the first security gateway may be a SEPP in a PLMN, such as PLMN B (FIG. 1). The second security gateway may be another SEPP in a different PLMN, such as PLMN A. The first domain name may be constructed based on a network ID of the second mobile communications network (e.g., PLMN A). The network ID may be a globally unique PLMN ID, and the first domain name may be a FQDN that includes the PLMN ID and a domain such as “3gppnetwork.org”.

In some cases, the act 210 of initiating communication between the first and the second security gateway may involve performing a DNS query using the first domain name to obtain a list of security gateways in the second mobile communications network (e.g., PLMN A). The DNS query may be a DNS NAPTR query. The first security gateway (e.g., in PLMN B) may select a security gateway from the list and initiate communication with the selected second security gateway in the second mobile communications network (e.g., PLMN A) as described above.

The next act 220 in the method 200 involves receiving a redirection response from the second security gateway (e.g., in PLMN A), which is indicative of a second domain name to be used for DNS-based discovery of another security gateway in the second mobile communications network. The redirection response may be received via an inter-mobile-communications-network-interface, such as inter-PLMN (N32) interface 120, 130. The redirection response may be a HTTP redirection response. In some aspects, the redirection response may inform the first security gateway (e.g., in PLMN B) that another security gateway (e.g., in PLMN A) should be used for communication. The redirection response may include a new information element (IE) that contains a data structure, which represents an FQDN. This FQDN may be interpreted to be used for DNS NAPTR queries.

Finally, based on the second domain name from the redirection response, the method 200 redirects 230 communication from the first security gateway (e.g., in PLMN B) to a third security gateway in the second mobile communications network (e.g., in PLMN A). The redirection 230 of communication may involve performing a second DNS query using the second domain name to dynamically discover a new target security gateway in the second mobile communications network (e.g., in PLMN A). The second DNS query may also be a DNS NAPTR query. The first security gateway (e.g., in PLMN B) may then redirect the communication to the new target security gateway (e.g., in PLMN A) based on the results of the second DNS query.

In some cases, the third security gateway (e.g., in PLMN A) may be another SEPP (e.g., SEPP 112A2) in the same PLMN as the second security gateway (e.g., SEPP 112A1). For example, if the second security gateway is in PLMN A, the third security gateway may also be in PLMN A. This allows a PLMN to direct certain roaming partners to dedicated SEPPs, enhancing flexibility in network management and traffic routing.

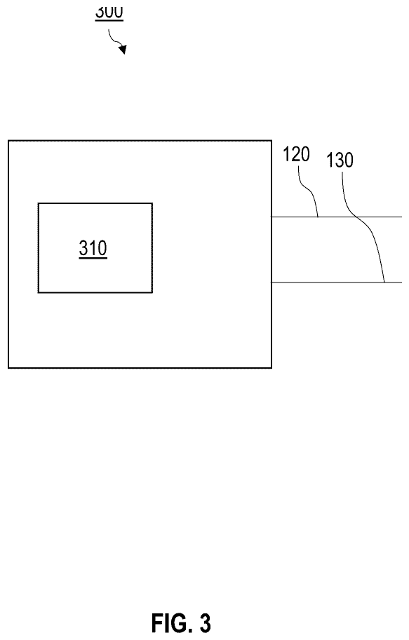

Referring to FIG. 3, the figure schematically illustrates an apparatus 300 for implementing the method 200 of dynamic discovery and redirection of security gateways in mobile communications networks. The apparatus 300 comprises processing circuitry 310 configured to perform various operations.

In some aspects, the processing circuitry 310 is configured to initiate communication between a first security gateway in a first mobile communications network (e.g., PLMN B) and a second security gateway in a second mobile communications network (e.g., PLMN A) based on a first domain name. The first security gateway and the second security gateway may be SEPPs in respective PLMNs. The first domain name may be a FQDN constructed based on a network ID of the second mobile communications network (e.g., PLMN A). The network ID may be a globally unique PLMN ID, and the first domain name may include the PLMN ID and a domain such as “3gppnetwork.org”.

In an implementation from the perspective of the initiating (first) security gateway, the processing circuitry 310 is further configured to receive a redirection response from the second security gateway (e.g., in PLMN A). In another implementation from the perspective of the rejecting (second) security gateway, the processing circuitry 310 is configured to transmit the redirection response to the first security gateway (e.g., in PLMN B). The redirection response may be indicative of a second domain name to be used for DNS-based discovery of another security gateway in the second mobile communications network. The redirection response may be received via an inter-mobile-communications-network-interface, such as an inter-PLMN interface 120, 130. The redirection response may be a HTTP redirection response that informs the first security gateway (e.g., in PLMN B) that another security gateway (e.g., in PLMN A) should be used for communication. The redirection response may include a new IE that contains a data structure, which represents an FQDN. This FQDN may be interpreted to be used for DNS NAPTR queries.

In some aspects, based on the second domain name, the processing circuitry 310 is configured to redirect the communication from the first security gateway in the first mobile communications network (e.g., PLMN B) to a third security gateway in the second mobile communications network (e.g., PLMN A). The redirection of communication may involve performing a second DNS query using the second domain name to dynamically discover a new target security gateway. The second DNS query may also be a DNS NAPTR query. The first security gateway (e.g., in PLMN B) may then redirect the communication to the new target security gateway (e.g., in PLMN A) based on the results of the second DNS query.

In some cases, the third security gateway (e.g., in PLMN B) may be another SEPP in the same PLMN as the second security gateway. For example, if the second security gateway is in PLMN A, the third security gateway may also be in PLMN A. This allows a PLMN to direct certain roaming partners to dedicated SEPPs, enhancing flexibility in network management and traffic routing.

The skilled person having benefit from the present disclosure will appreciate that apparatus 300 can be implemented within a SEPP to support the dynamic discovery and redirection of security gateways in mobile communication networks. The apparatus 300 includes processing circuitry 310 that initiates communication between security gateways based on domain names constructed from network identifiers, such as PLMN IDs. The processing circuitry 310 is also capable of handling redirection responses from SEPPs, interpreting these responses to dynamically redirect communication to more appropriate security gateways. In terms of hardware and software, the processing circuitry 310 may be used for executing DNS NAPTR queries and handling HTTP redirection responses. This circuitry may be a combination of a processor and software modules that manage DNS queries, FQDN resolution, and communication routing. The apparatus 300 may ensure that if a SEPP is not the optimal target for communication, it can dynamically redirect traffic to another SEPP in the same network, thereby enhancing network flexibility and efficiency. This redirection mechanism can be implemented using standard networking hardware combined with software that adheres to 3GPP protocols, such as those defined for the N32 interface.

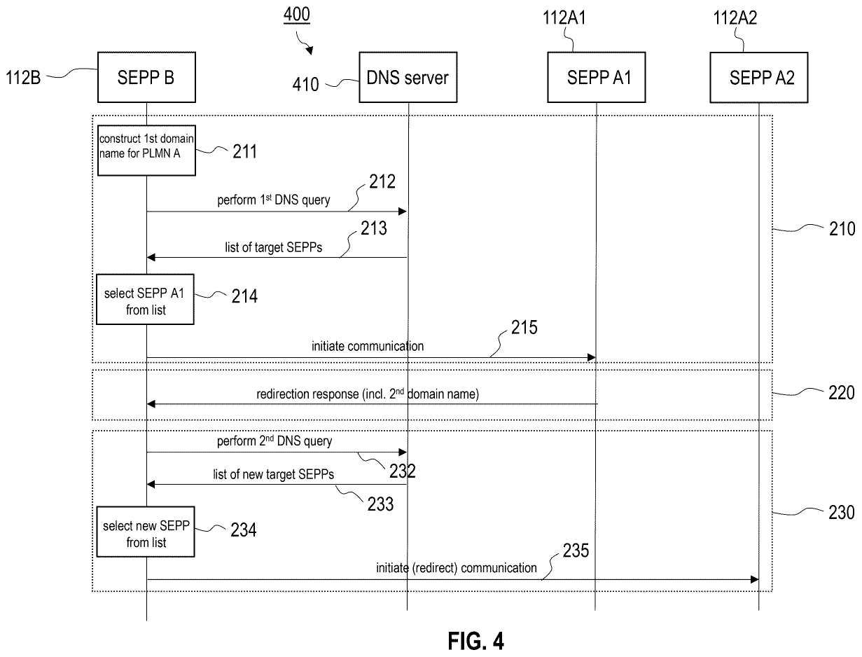

Referring to FIG. 4, it is illustrated a more detailed sequence diagram 400 of a dynamic discovery and redirection process for security gateways 112 in mobile communications networks. The illustrated process involves four main entities: a first security gateway 112B, a DNS server 410, a second security gateway 112A1, and a third security gateway 112A2.

The sequence begins with the first security gateway 112B (e.g., in PLMN B) constructing the first domain name for a target security gateway in the second mobile communications network (e.g., PLMN A) based on the network ID of the second mobile communications network (step 211). This construction of the first domain name may be based on a globally unique PLMN ID, and the first domain name may be a well-known FQDN that includes the PLMN ID and a domain such as “3gppnetwork.org”. The well-known FQDN is the initial domain name constructed based on the target mobile network's (e.g., PLMN A) information. It is called “well-known” because it follows a standardized naming convention, allowing any network to locate security gateways (SEPPs) in another network. This FQDN is generated using the PLMN ID of the second mobile communications network (e.g., PLMN A). The PLMN ID may comprise the mobile country code (MCC) and the mobile network code (MNC), which uniquely identifies the network.

Next, the first security gateway 112B performs a DNS query using the first domain name (well-known FQDN) to obtain a list of security gateways in the second mobile communications network (step 212). The DNS query may be NAPTR query, which is a specific type of DNS query used for service discovery. The well-known FQDN may be used in the first DNS query to discover SEPPs in the target network (e.g., PLMN A). This domain name serves as a unique identifier for the target network and allows the security gateway to perform a DNS lookup. The NAPTR query resolves the well-known FQDN into a list of potential SEPPs within the target network. These SEPPs are security gateways responsible for managing secure communications between different PLMNs. The response to this query may provide a prioritized list of SEPPs, including their capabilities and services, which the initiating SEPP (112B) can use to establish secure communication with the most appropriate SEPP in PLMN A. By using a NAPTR query, the first security gateway is able to dynamically discover the available SEPPs in the target network, allowing for real-time decisions on routing traffic through the most optimal gateway.

The DNS server 410 responds with a list of target security gateways (step 213). When the DNS server 410 receives the DNS query from the first security gateway 112B, it may process the request by looking up records associated with the well-known FQDN provided in the query. The DNS server 410 may be responsible for maintaining a database of domain names and their corresponding network services, including the security gateways or SEPPs available in the target network. Upon resolving the query, the DNS server 410 responds by sending back a list of target security gateways, e.g., in the form of FQDNs. Each FQDN may represent a SEPP within the second mobile communications network (e.g., PLMN A). This response might also include additional details, such as priority and weighting values for each SEPP, allowing the initiating security gateway to choose the most appropriate SEPP for communication. If the query is a NAPTR query, the DNS server 410 may return service records that provide not only the FQDNs of the available SEPPs but also indicate the specific functions or services each SEPP is configured to handle. This may enable the initiating security gateway 112B to resolve the appropriate SEPP for the type of communication or traffic being handled.

Once the list is received, the first security gateway 112B selects a security gateway from the list (step 214) and initiates communication with the selected second security gateway 112A1 in the second mobile communications network (step 215). Once the first security gateway 112B receives the list of SEPPs from the DNS server 410, it may proceed to select one of the SEPPs based on several potential criteria, such as priority, load, geographical location, or service type. The list returned by the DNS server 410 may include additional metadata, like priority and weight, which help the gateway determine the most suitable SEPP for the communication.

After selecting the appropriate SEPP 112A1 in the second network, the first security gateway 112B initiates communication. To do this, the selected SEPP's FQDN from the list may need to be further resolved into an IP address, using another DNS query, such as an A or AAAA query for IPv4 or IPv6 addresses, respectively. Once the IP address is obtained, the first security gateway 112B may establish a secure communication link to the selected SEPP 112A1 in the second mobile communications network. This communication initiation 215 may involve exchanging signaling messages, possibly over an encrypted channel like TLS, as SEPPs are designed to secure the edges of networks. The traffic between the two SEPPs may now be secured, ensuring that sensitive data remains protected while it travels between the two mobile networks, typically in scenarios like roaming or inter-network communication. The SEPP 112A1 in the second mobile network may then handle the routing and security of the traffic within its own network.

However, the second security gateway 112A1 responds with a redirection response that includes a second domain name to be used for DNS-based discovery of another security gateway in the second mobile communications network (step 220). This redirection response may be a HTTP redirection response that informs the first security gateway 112B that another security gateway should be used for communication. The redirection response may include an IE that contains a data structure, which represents an FQDN. This FQDN may be interpreted to be used for DNS NAPTR queries. When the first security gateway 112B initiates communication with the selected second security gateway 112A1 in the target network (PLMN A), the second gateway 112A1 may determine that it is not the most suitable SEPP to handle the traffic. In response, the second security gateway 112A1 issues a HTTP redirection response to inform the initiating SEPP 112B that communication should be directed to a different security gateway within the same network. The first security gateway 112B may interpret the second FQDN from the HTTP redirection response and uses it to initiate a new DNS discovery process.

SEPP-A1 in PLMN-A receives an HTTP request (N32 interface) from SEPP-B in PLMN-B. However, SEPP-A1 decides that SEPP-B should be communicating with a different SEPP within PLMN-A, so it redirects the request. To redirect SEPP-B to the correct SEPP within PLMN-A, SEPP-A1 sends an HTTP 307 Temporary Redirect response. This response may include a data structure called ExtRedirectResponse, which may contain attributes. A first attribute (‘cause’ attribute) may specify a reason or trigger for the redirection. It may provide information to the receiving entity (in this case, SEPP-B) about why the redirection is occurring. In this context, it may signal that the redirection involves a discovery process, instructing SEPP-B to look for another service or entity within the network. A second attribute (‘seppFqdnForDiscovery’ attribute) may contain a FQDN that serves as a reference for the receiving entity (SEPP-B) to initiate a new discovery process. It may point to a target or service that the receiving entity should locate, typically by performing a DNS query. The FQDN may act as a dynamic address that the system can use to find the most appropriate resource without pre-configuring specific targets.
‘cause’ attribute: Set to a value such as ‘SEPP_REDIRECTION_WITH_DISCOVERY’, indicating that redirection should involve a discovery procedure.
‘seppFqdnForDiscovery’ attribute: contains the Fully Qualified Domain Name (FQDN) that SEPP-B will use to discover the new SEPP via DNS-based discovery.

SEPP-B may ignore the standard HTTP Location header in the response. Instead, it may use the FQDN provided in the ‘seppFqdnForDiscovery’ attribute. With this FQDN, SEPP-B can perform a DNS NAPTR query to automatically discover the appropriate SEPP within PLMN-A.

Thus, upon receiving the redirection response from the second gateway 112A1, the first security gateway 112B performs a second DNS query using the second domain name (second FQDN) to dynamically discover a new target security gateway (step 232). The second DNS query may be a second NAPTR query. The second FQDN may be used in the second DNS query to discover new SEPPs in the target network (e.g., PLMN A).

The DNS server 410 responds with a list of new target security gateways (step 233). The first security gateway 112B then selects a new security gateway from this updated list (step 234) based on several potential criteria, such as priority, load, geographical location, or service type. In this case, the new security gateway is the third security gateway 112A2.

After selecting the new target SEPP 112A2 in the second network, the first security gateway 112B initiates a redirect communication with the newly selected third security gateway 112A2 (step 235). To do this, the selected new target SEPP's FQDN from the list may need to be further resolved into an IP address, using another DNS query, such as an A or AAAA query for IPv4 or IPv6 addresses, respectively. Once the IP address is obtained, the first security gateway 112B may establish a secure communication link to the selected new target SEPP 112A2 in the second mobile communications network. This communication initiation 235 may involve exchanging signaling messages, possibly over an encrypted channel like TLS, as SEPPs are designed to secure the edges of networks. The traffic between the two SEPPs 112B, 112A2 is now secured, ensuring that sensitive data remains protected while it travels between the two mobile networks, typically in scenarios like roaming or inter-network communication. The SEPP 112A2 in the second mobile network may then handle the routing and security of the traffic within its own network.

Embodiments of the present disclosure may treat all SEPP-to-SEPP communication initiation all the same, regardless of whether there is a redirection or not. If one starts resolving the well-known FQDN, one gets the list of SEPPs FQDNs. One talks to a SEPP and this one sends a redirect. The new target FQDN from the redirect may then again run through the same discovery procedure, i.e. performing a NAPTR resolution on that FQDN received in the redirect. This way, the initiating SEPP may learn the list of possible new target SEPPs. In case of the redirect within the same PLMN, i.e. redirection is made to another SEPP of which the FQDN is already in the list received via DNS discovery, a new NAPTR request would be of little value. However, there is a use case where the FQDN received in the redirect would be another general FQDN and the list of SEPPs FQNDs received from a NAPTR request based on this new general FQDN would be different. It may be possible for a PLMN to have more than one SEPP for the same PLMN ID(s). There may be no need to inform roaming partner about the intended destination SEPP upfront—only dynamic discovery may be intended.

Embodiments of the present disclosure define a new mechanism of SEPP HTTP Redirection response by introducing a new API attribute to make sure that the RedirectionResponse data type will be resulted in an FQDN which can be used for a new SEPP discovery procedure and a new NAPTR query which will help getting the list of possible new target SEPPs. This new mechanism may assure the dynamic discovery of the destination SEPP and to avoid informing the roaming partners about the intended responding SEPPs upfront. An embodiment uses HTTP redirect and defines for the redirect response message a new IE that contains a data structure, which represents an FQDN. This FQDN may be interpreted to be used for DNS NAPTR queries (in contrast to the HTTP Location Header, which is defined to be a host FQDN).

An embodiment may use HTTP redirect for the N32 interface as specified in TS 29.500 for the non-N32 interface, where the HTTP Location Header may be ignored. A new IE may be defined (different from the already defined one), which may be used instead of the Location Header. The new IE may contain a data structure that represents an FQDN. This FQDN can be used by the SEPP that receives the redirect response to issue a DNS NAPTR query for SEPP discovery.

The present disclosure provides a method, apparatus, and system for dynamic discovery and redirection of security gateways in mobile communications networks. This may be particularly relevant in the context of 5G networks, where Security Edge Protection Proxies (SEPPs) play a crucial role in safeguarding the edges of mobile networks and facilitating secure inter-network communication. The disclosed method and apparatus address the need for more flexible and dynamic routing of traffic to specific SEPPs based on various criteria or preferences, a capability that is currently lacking in existing standards. This may be particularly beneficial in scenarios where a public land mobile network (PLMN) operator wishes to direct certain roaming partners to dedicated SEPPs while using different ones for others. The disclosed method and apparatus may also overcome the limitations of the static nature of DNS responses in the current setup, enabling a new round of DNS-based SEPP discovery upon redirection and thereby facilitating advanced load balancing or failover strategies. Furthermore, the disclosed method and apparatus eliminate the need for prior configuration or knowledge by the initiating network, thereby reducing complexity in network management and enhancing agility in responding to changing network conditions or security requirements.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim, or a combination of features of independent claims with each other. Such combinations are hereby explicitly proposed, unless it is stated in the individual case that a particular combination is not intended.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for dynamic discovery and redirection of security gateways in mobile communications networks, the method comprising:
based on a first domain name, initiating, by a first security gateway in a first mobile communications network, communication between the first security gateway in the first mobile communications network and a second security gateway in a second mobile communications network;
receiving, by the first security gateway, a redirection response from the second security gateway, the redirection response being indicative of a second domain name to be used for Domain Name System (DNS)-based discovery of another security gateway in the second mobile communications network; and
based on the second domain name, initiating, by the first security gateway, communication between the first security gateway in the first mobile communications network and a third security gateway in the second mobile communications network.

2. The method of claim 1, wherein the inter-mobile-communications-network-interface is an inter-public land mobile network (PLMN) interface.

3. The method of claim 1, wherein initiating communication between the first and second security gateways comprises:
constructing the first domain name for a target security gateway in the second mobile communications network based on a network ID of the second mobile communications network.

4. The method of claim 1, wherein initiating communication between the first and the second security gateway comprises:
performing a DNS query using the first domain name to obtain a list of security gateways in the second mobile communications network.

5. The method of claim 4, further comprising
selecting a security gateway from the list and initiating communication between the first security gateway and the selected second security gateway in the second mobile communications network.

6. The method of claim 4, wherein the DNS query comprises a DNS Naming Authority Pointer (NAPTR) query.

7. The method of claim 1, wherein initiating communication between the first and the third security gateway comprises:
performing a second DNS query using the second domain name to dynamically discover a new target security gateway.

8. The method of claim 7, further comprising:
communicating with the new target security gateway based on results of the second DNS query.

9. The method of claim 1, wherein the first and second security gateways comprise respective Security Edge Protection Proxies (SEPPs).

10. The method of claim 1, wherein the first and second mobile communications networks comprise respective 5G Standalone (SA) networks.

11. The method of claim 1, wherein the first and second domain names comprise respective fully qualified domain names (FQDNs).

12. The method of claim 1, wherein the redirection response comprises a Hypertext Transfer Protocol (HTTP) redirection response.

13. A non-transitory computer-readable medium having processor-executable stored thereon for dynamic discovery and redirection of security gateways in mobile communications networks, wherein the processor-executable instructions, when executed, facilitates performance of the following:
based on a first domain name, initiating communication between a first security gateway in a first mobile communications network and a second security gateway in a second mobile communications network;
receiving a redirection response from the second security gateway, the redirection response being indicative of a second domain name to be used for Domain Name System (DNS)-based discovery of another security gateway in the second mobile communications network; and
based on the second domain name, initiating communication between the first security gateway in the first mobile communications network and a third security gateway in the second mobile communications network.

14. A method for dynamic discovery and redirection of security gateways in mobile communications networks, the method comprising:
based on a first domain name, communicating, by a second security gateway in a second mobile communications network, with a first security gateway in a first mobile communications network; and
transmitting, by the second security gateway, a redirection response from the second security gateway to the first security gateway, the redirection response being indicative of a second domain name to be used for Domain Name System (DNS)-based discovery of another security gateway in the second mobile communications network.

15. A non-transitory computer-readable medium having processor-executable stored thereon for dynamic discovery and redirection of security gateways in mobile communications networks, wherein the processor-executable instructions, when executed, facilitates performance of the following:
based on a first domain name, communicating between a first security gateway in a first mobile communications network and a second security gateway in a second mobile communications network; and
transmitting a redirection response from the second security gateway to the first security gateway, the redirection response being indicative of a second domain name to be used for Domain Name System (DNS)-based discovery of another security gateway in the second mobile communications network.
